(19) United States
(12) Patent Application Publication
(10) Pub. No.: US 2019/0100687 A1
(43) Pub. Date: Apr. 4, 2019

(54) METHODS AND COMPOSITIONS FOR FILTER CAKE REMOVAL

(71) Applicant: ETHICAL SOLUTIONS, LLC, SOUTH WINDSOR, CT (US)

(72) Inventors: Daniel J. SOCCI, West Hartford, CT (US); Jennifer L. HOLCOMB, Torrington, CT (US)

(21) Appl. No.: 16/149,490

(22) Filed: Oct. 2, 2018

Related U.S. Application Data
(60) Provisional application No. 62/566,578, filed on Oct. 2, 2017.

(51) Int. Cl. C09K 8/528; C09K 8/14; C09K 8/86; C09K 8/68; C09K 8/584; E21B 37/06

(52) U.S. Cl. CPC C09K 8/528; C09K 8/14; E21B 37/06; C09K 8/68; C09K 8/584; C09K 8/86

(57) ABSTRACT

The present disclosure provides methods for degrading filter cake and filter cake removal, and compositions for removing filter cake from a subterranean borehole. The methods involve contacting the filter cake with a composition containing an unencapsulated peroxygen and a surfactant, and allowing the composition to remain in contact with the filter cake at a temperature above 165° F. for a period of time sufficient to degrade the filter cake. The methods result in acidic conditions, thereby eliminating any need for follow up acid treatments. The composition is stable enough to effectively remove filter cake at temperatures above 165° F. (preferably, up to 250° F. or greater). Through filter cake removal resulting in improved permeability, the method provides for increased flow, production, and/or recovery of oil and gas hydrocarbons from a subterranean formation.

### RELATED APPLICATION

This application claims the benefit of U.S. Provisional Application Ser. No. 62/566,578, filed on Oct. 2, 2017, which is incorporated herein by reference in its entirety.

### BACKGROUND OF THE DISCLOSURE

### 1. Field of the Disclosure

The present disclosure relates to methods and compositions for filter cake removal. More particularly, the present disclosure relates to a method that involves contacting the filter cake with a composition containing an unencapsulated peroxygen and a surfactant, and allowing the composition to remain in contact with the filter cake at a temperature above 165° F. for a period of time sufficient to degrade the filter cake. The present disclosure also relates to a composition for filter cake removal containing an unencapsulated peroxygen and a surfactant in an amount sufficient to allow the composition to remain downhole at a temperature above 165° F. for a period of time sufficient to degrade the filter cake. The treatment method results in acidic conditions, thereby eliminating any need for follow up acid treatments.

### 2. Description of the Related Art

Drilling muds are used in the oil and gas industry during the process of drilling boreholes into the earth. The addition of drilling muds (or drilling fluids) has multiple functions, including providing hydrostatic pressure to prevent formation fluids from entering the wellbore, prevention of formation damage, keeping the drill bit cool, and lifting and suspending drill cuttings to the surface. Drilling muds can either be water-based muds or oil-based muds. Oil-based drilling fluids are used in formations with clays that react, swell, or slough when exposed to water-based fluids, and are also able to be used at higher temperatures.

As the drilling fluid is forced against permeable mediums within the wellbore, residue is deposited resulting in the formation of filter cake or mudcake. Upon completion of the drilling, the mudcake must be removed to allow production of the formation fluids. Removal of the filter cake must be as complete as possible in order to recover permeability within the formation.

A common problem with current treatment methods is the lack of control in uniform breakdown of the filter cake which results in worm holes, through which the treatment fluid then enters. As such, current treatment methods may include multiple treatment steps to achieve the desired outcome, including an acid injection treatment to dissolve carbonates, found in the mud, and/or certain polymers.

Several methods of filter cake removal exist that include beginning with a filter cake composition designed to react with a subsequent treatment step. Dobson, Jr. et al., U.S. Pat. No. 5,607,905 is directed to a process for enhancing removal of filter cake in which an alkaline earth metal peroxide as an integral component is deposited within the filter cake. Upon contacting the filter cake with an acid solution treatment, the peroxide becomes activated for a period of time such that the polymer within the filter cake will decompose. Hollenbeck et al. U.S. Pat. No. 4,809,783 is directed to a method for dissolving polysaccharide-containing filter cake by injecting effective amounts of treatment fluid comprising a soluble source of fluoride ions present in an amount sufficient to provide a molar concentration of from about 0.01 to about 0.5, having a pH in the range of from about 2 to about 4. Hollenbeck also is directed to that the said treatment fluid may contain an effective amount of oxidizer capable of degrading the polysaccharide present in the filter cake upon disruption of the metal ion-polysaccharide complex. That oxidizer may be sodium persulfate.

Each of these methods includes dependency on a previous or subsequent step in order to achieve the most effective results. A need exists for a single treatment that will provide effective, controlled, uniform filter cake breakdown under a wide temperature range. The single treatment should achieve filter cake removal and enhanced permeability to enable an increase in the production rates and/or recovery of hydrocarbons.

### SUMMARY OF THE DISCLOSURE

The present disclosure provides a method for filter cake removal, and a composition for removing filter cake from a subterranean borehole.

The present disclosure also provides a method that involves contacting the filter cake with a composition containing an unencapsulated peroxygen and a surfactant, and allowing the composition to remain in contact with the filter cake at a temperature above 165° F. for a period of time sufficient to degrade the filter cake.

The present disclosure further relates to a composition for filter cake removal containing an unencapsulated peroxygen and a surfactant in an amount sufficient to allow the composition to remain downhole at a temperature above 165° F. for a period of time sufficient to degrade the filter cake. The treatment results in acidic conditions, thereby eliminating any need for follow up acid treatments.

The present disclosure still further provides a one-step method for degrading filter cake. The method involves contacting the filter cake with a composition comprising (a) an unencapsulated peroxygen, and (b) a surfactant; and allowing the composition to remain downhole at a temperature above 165° F. for a period of time sufficient to degrade the filter cake. The treatment method results in acidic conditions, thereby eliminating any need for follow up acid treatments.

The present disclosure also provides a composition for removing filter cake from a subterranean borehole and a method for filter cake removal which is effective at temperatures up to 250° F. or greater.

The present disclosure further provides a composition containing (a) an unencapsulated peroxygen, and (b) a surfactant, in which the unencapsulated peroxygen and the surfactant are present in an amount sufficient to allow the composition to remain downhole at a temperature above 165° F. for a period of time sufficient to degrade the filter cake (e.g., at temperatures as high as 250° F. or greater).

The present disclosure still further provides compositions and methods of using a single fluid treatment for removing filter cake from a subterranean borehole to increase flow, production, and/or recovery of oil and gas. The compositions include uncoated peroxygen compounds and surfactant, and the treatment method creates acidic conditions.

In accordance with this disclosure, a method is provided for removing filter cake from subterranean boreholes and wellbores in a one-step treatment process at temperatures up to 250° F. or greater. The composition can include a surfactant with an unencapsulated peroxygen compound. At least one component can be mixed with fresh water, brine water, formation water, water with potassium chloride or other salts added, or combinations prior to introduction into the subterranean formation. The treatment may also comprise a solvent to aid in dissolving oils and further breakdown of oil based filter cakes. The treatment method results in acidic conditions, thereby eliminating any need for follow up acid treatments.

The present disclosure also provides method of removing filter cake from a subterranean borehole. The method comprises drilling a borehole with a drill-in fluid to form a filter cake; contacting the filter cake with a composition comprising (a) an unencapsulated peroxygen and (b) a surfactant, and allowing the composition to remain downhole at a temperature above 165° F. for a period of time sufficient to degrade the filter cake.

The present disclosure further provides a composition for removing filter cake from a subterranean borehole in which the filter cake is chemically broken down by the composition via direct oxidation or free radical oxidation. The composition contains an oxidant that is an unencapsulated peroxygen.

The present disclosure preferably provides a one step process for removing filter cake from subterranean boreholes and wellbores. The process of this disclosure results in acidic conditions, thereby eliminating any need for follow up acid treatments.

In the methods of this disclosure, permeability of a subterranean formation is surprisingly improved as compared to permeability of a subterranean formation in which a filter cake is contacted with a composition comprising (a) an encapsulated peroxygen and (b) a surfactant. Also, in the methods of this disclosure, permeability of a subterranean formation is surprisingly improved as compared to permeability of a subterranean formation in which a filter cake is contacted with a composition comprising (a) an unencapsulated peroxygen and (b) a surfactant, and the composition can remain downhole at a temperature below 165° F.

Through filter cake removal, the compositions and methods of this disclosure provide for increased flow, production, and/or recovery of oil and gas hydrocarbons from a subterranean formation.

These and other systems, methods, objects, features, and advantages of the present disclosure will be apparent to those skilled in the art from the following detailed description of the preferred embodiment and the drawings.

### BRIEF DESCRIPTION OF THE DRAWINGS

FIG. 1 is a table showing ingredients and amounts thereof of an optimized oil-based drilling mud prepared in Example 1.

FIG. 2 is a table showing properties of a core sample in Example 1.

FIG. 3 is a table showing conditions used in breaking the filter cake in Example 2.

FIG. 4 is a table and photographs showing filter cake removal results in Example 2.

FIG. 5 is a table showing filtrate analysis for Na⁺, K⁺, Mg²⁺, Ca²⁺, Fe^{2+/3+} and Al³⁺ in Example 2.

FIG. 6 is a table showing conditions used in breaking the filter cake in Example 3.

FIG. 7 is a table and photographs showing filter cake removal results in Example 3.

FIG. 8 is a table showing filtrate analysis for Na⁺, K⁺, Mg²⁺, Ca²⁺, Fe^{2+/3+} and Al³⁺ in Example 3.

FIG. 9 is a table showing conditions used in breaking the filter cake in Example 4.

FIG. 10 is a table and photographs showing filter cake removal results in Example 4.

FIG. 11 is a table showing filtrate analysis for Na⁺, K⁺, Mg²⁺, Ca²⁺, Fe^{2+/3+} and Al³⁺ in Example 4.

### DESCRIPTION OF THE EMBODIMENTS

Embodiments of the present disclosure are described more fully hereinafter with reference to the accompanying drawings, in which some, but not all, embodiments of the present disclosure are shown. Indeed, the present disclosure can be embodied in many different forms and should not be construed as limited to the embodiments set forth herein. Rather, these exemplary embodiments are provided so that the present disclosure satisfies applicable legal requirements. Also, like numbers refer to like elements throughout.

In an embodiment, the present disclosure provides a composition for removing filter cake from a subterranean borehole and a method for filter cake removal. The filter cake removal allows for increasing flow, production, and/or recovery of oil and gas hydrocarbons from a wellbore or a portion of a subterranean formation. The composition can include an unencapsulated peroxygen, a surfactant, an alkali metal chelate and a solvent.

For example, the unencapsulated peroxygen can be an unencapsulated peroxide, an unencapsulated source of peroxide, unencapsulated sodium persulfate, unencapsulated potassium persulfate, unencapsulated ammonium persulfate, or any combinations thereof.

For example, the surfactants can be nonionic plant based surfactants such as fatty alcohol ethoxylates, fatty acid ethoxylates, fatty acid esters, fatty acid methyl ester ethoxylates, alkyl polyglucosides, polyalcohol ethoxylates, soy alkyltrimethyl ammonium chlorides, a monococoate, or any combinations. The nonionic surfactant can be an ethoxylated coco fatty acid, an ethoxylated coco fatty ester, an ethoxylated cocoamide, an ethoxylated castor oil, a monococoate, and combinations.

Examples of solvents include, for example, terpenoid- or methyl soyate-ethyl lactate-, methyl lactate- or ethyl acetate-based compounds or combinations.

The surfactants and solvents can provide further stabilization of the peroxygens in the well bore and subterranean formation.

Examples of alkali metal chelates are sodium or potassium chelates. The alkali metal chelate can serve the purpose of scavenging ionic or bound phases of metals in a formation, such as iron, thereby extending the life of the peroxygen and making the peroxygen more stable in the well bore or subterranean formation and increasing the peroxygen penetration in the formation.

The stability of this composition allows for treatment in formations with temperatures above 165° F., 175° F., 180° F., 200° F., 225° F., 250° F., 300° F., 350° F., 400° F., 450° F., even temperatures up to 500° F. or greater.

In another embodiment, the composition of this disclosure includes a fluid for removing filter cake from a subterranean borehole thereby increasing flow, production, and/or recovery of hydrocarbons from a wellbore or a portion of a subterranean formation. The composition includes an unencapsulated peroxygen and a surfactant. The composition also optionally includes an alkali chelate, e.g., a sodium or potassium chelate and a solvent. The fluid is applied to a portion of a wellbore or an adjacent subterranean formation, for example, as a drilling fluid, or a well bore treatment. The fluid application is for oil or gas production stimulation, slick water fracturing, enhanced oil recovery, or any combinations of these.

The unencapsulated peroxygen compound can be present in a final concentration applied to the wellbore or subterranean formation that varies from 0.01 to 20 percent by weight of peroxygen, for example, from 0.01 to 10 percent by weight of peroxygen. The pH of the composition can be adjusted if needed to avoid pH changes in the formation.

In some embodiments, the concentration of the unencapsulated peroxygen introduced into the wellbore or subterranean formation is between about 0.01 and about 20 percent by weight. The concentration is determined by dividing the weight of the unencapsulated peroxygen by the total weight of the composition when it is introduced into the wellbore or subterranean formation. In some embodiments, the concentration of unencapsulated peroxygen is greater than about 0.01, 0.05, or 0.1 percent by weight of peroxygen. In some embodiments, the concentration of unencapsulated peroxygen is less than about 15, 12, 10, 8, or 5 percent by weight of peroxygen. In some embodiments the concentration of unencapsulated peroxygen relative to the non-water components is greater than about 1, 2, 5, or 10 percent by weight of peroxygen. In some embodiments the concentration of unencapsulated peroxygen relative to the non-water components is less than about 35, 30 or 25 percent by weight of peroxygen relative to the non-water components. The concentration relative to the non-water components is determined by dividing the weight of unencapsulated peroxygen by the total weight of the non-water components.

In accordance with this disclosure, the peroxygen chemically breaks down the filter cake via a direct oxidation pathway or via a free radical pathway.

In another embodiment, the surfactant can be, for example, a nonionic surfactant selected from an ethoxylated coco fatty acid, an ethoxylated coco fatty ester, an ethoxylated cocoamide, an ethoxylated castor oil, a monococoate, and combinations thereof.

In a further embodiment, the surfactant can be, for example, the ethoxylated coco fatty acid can be a polyethylene glycol (PEG) coco fatty acid having a range of about 5 to about 40 PEG groups, and a Hydrophile-Lipophile Balance (HLB) range from about 10 to about 19; the ethoxylated castor oil can be a polyethylene glycol (PEG) castor oil having a range of about 2.5 to about 40 PEG groups, and a Hydrophile-Lipophile Balance (HLB) range from about 2.1 to about 16; the ethoxylated cocoamide can be a polyethylene glycol (PEG) cocamide having a range of about 2 to about 20 PEG groups, and a Hydrophile-Lipophile Balance (HLB) range from about 2 to about 19.

The sorbitan ester based surfactants be the following: sorbitan monooleate with an HLB of 4.8: sorbitan monolaurate with an HLB of 8.6; sorbitan monopalmitate with an HLB of 6.5; and sorbitan monostearate with an HLB of 4.7. The ethoxylated sorbitan ester based surfactants can be the following: polyoxyethylene (20) sorbitan monooleate with an HLB of 15; polyoxyethylene(20) sorbitan monopalmitate with an HLB of 15.6; polyoxyethylene (20) sorbitan monostearate with an HLB of 14.9; and polyoxyethylene(20) sorbitan monooleate with an HLB of 15.0. The surfactant can be present in a final concentration as applied to the wellbore or subterranean formation that varies from 0.01 to 50 percent, for example, from 0.05 to 5 percent by weight.

In a yet further embodiment, the surfactant can be, for example, the surfactant can be a sorbitan ester selected from sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

In another embodiment, the surfactant can be, for example, the surfactant can be an ethoxylated sorbitan ester selected from a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

In some embodiments, the surfactant concentration in the composition when introduced into the wellbore or subterranean formation can be between about 0.01 and about 50 percent by weight. Again, the surfactant concentration is measured by dividing the total weight of the surfactant by the total weight of the composition. The concentration can be greater than about 0.01, 0.03, 0.05, 0.1, 0.5, or 1 by weight or less than about 50, 45, 40, 35, 30, 25, 20, 15, 10, or 5 percent by weight. Relative to the non-water components, the surfactant concentration can be greater than about 5, 10, 15, 20, 25, or 30 percent or less than about 95%, 90%, 85%, or 80%. The surfactant concentration relative to the non-water components is determined by dividing the total weight of the surfactant by the total weight of the non-water components in the composition.

The composition of this disclosure can optionally include a chelate, such as a mono-, di-, tri-, or tetra-sodium ethylenediaminetetraacetic acid (EDTA), a mono-, di-, tri-, or tetra-potassium ethylenediaminetetraacetic acid (EDTA) or sodium ethylenediamine-N,N-disuccinic acid (EDDS), or any combinations. The selected chelate can be present in a final concentration as applied to the wellbore or subterranean formation that varies from 0.0001 to 5.0 percent by weight. For example, the chelate can be sodium EDTA.

In some embodiments, the chelate concentration in the composition when introduced into the wellbore or subterranean formation is between about 0.00001 to about 5 percent by weight. The concentration is determined by dividing the total weight of the chelate by the total weight of the composition. The concentration can be greater than about 0.0001, 0.00002, 0.0001, 0.001, 0.002, 0.01, or 0.1 percent. The concentration can be less than about 5.0, 4.0, 3.0, 2.0, 1.0, or 0.5 percent. The chelate concentration, relative to the non-water components can be between about 0.2 and about 5 percent by weight. The chelate concentration relative to the non-water components is determined by dividing the total weight of the chelate by the total weight of the non-water components of the composition. The chelate concentration relative to the non-water components, can be greater than about 0.2, 0.5, 0.7, or 1.0 percent, or less than about 5, 4.5, 4, 3.5, 3, 2.5, or 2 percent by weight.

The composition of this disclosure can optionally include a solvent, such as a terpene, for example, hemiterpene, a monoterpene, a sesquiterpene, a diterpene, a sesterterpene, a triterpene, a tetraterpene, or any combinations. For example, the terpene can be a monoterpene, such as geraniol; d-limonene, or terpineol, or combinations. For example, the terpene can be a citrus derived terpene, or a terpene derived from conifers. The selected terpene concentration in the composition can be present in a final concentration as applied to the wellbore or subterranean formation that varies from 0.001% to 50% by weight, for example, from 0.01% to 10% by weight. A soy derived solvent, such as methyl soyate, can be a solvent in the composition. The methyl soyate concentration can be present in a final concentration as applied to the wellbore or subterranean formation that varies from 0.001% to 50% by weight, for example, from 0.01% to 10% by weight. Ethyl lactate, methyl lactate or ethyl acetate may also be used as solvents.

In some embodiments, the solvent concentration in the composition when introduced into the wellbore or subterranean formation can be between about 0.001 and about 50 percent. The concentration is determined by dividing the total weight of solvent by the total weight of the composition introduced into the wellbore or subterranean formation. In some embodiments, the concentration of solvent is greater than about 0.001, 0.002, 0.005, 0.007, or 0.01 percent. In some embodiments, the solvent concentration is less than about 50, 30, 25, 20, 15, 10, 8, or 5 percent. The solvent concentration relative to the non-water components can be between about 1 and about 40 percent by weight. The solvent concentration relative to the non-water components, is determined by dividing the total weight of solvent by the total weight of the non-water components in the composition. The solvent concentration, relative to the non-water components can be greater than about 1, 5, 7, 10, 12, or 15 by weight. The solvent concentration relative to the non-water components can be less than about 80, 75, 70, 65, 60, 55, 50, 45, or 40 percent by weight.

In some embodiments, the composition further comprises an antioxidant. The antioxidant can be, for example, a plant-derived polyphenol. The plant-derived polyphenol can be, for example, derived from sorghum bran. An antioxidant can be included in the composition to stabilize and control the rate of peroxygen decay.

In the method of this disclosure, filter cake formed on the walls of a subterranean borehole is removed by contacting the filter cake with a composition containing an unencapsulated peroxygen and a surfactant. Filter cakes are coatings that reduce the permeability of formation walls. Formed during the drilling stage to limit losses from the well bore and protect the formation from possible damage by fluids and solids within the well bore, filter cake layers must be removed from the hydrocarbon-bearing formation so that the formation wall is restored to its natural permeability to allow for hydrocarbon production or cementing.

Filter cakes are typically formed with polymers that encapsulate particles or solids that form a bridge over the formation pores. Drill-in fluids, including any bridging agents and polymers contained within the drilling fluid, are well known in the art. In one preferred method of this disclosure, removing filter cake from a subterranean borehole involves drilling the borehole with a drill-in fluid comprising a polymer to form a filter cake. Preferably, the borehole is drilled while circulating a mud therein that comprises a polymer. The polymer is selected from a water soluble organic polymer, a water dispersible organic polymer, a water soluble bio-polymer, a water dispersible bio-polymer, or any combinations thereof. For example, the polymer selected can be a cationic starch, an anionic starch or a nonionic starch. Optionally, the drill-in fluid comprises finely divided solids dispersed therein to form a filter cake on surfaces of the borehole. Other additives can be used for stabilizing and viscosifying.

When the bore hole is ready for production, the filter cake must be removed to allow for permeability of the formation walls. To remove the filter cake, the filter cake is contacted with a mixture containing an unencapsulated peroxygen and a surfactant, in a variable density brine. In one aspect, the mixture can further include a chelating agent. Preferably, the uncoated peroxygen is ammonium persulfate. Alternatively, the peroxygen is selected from an alkali metal peroxygen, an alkaline earth metal peroxygen, or any combinations thereof. The alkali metal peroxygen can be selected from potassium persulfate, sodium persulfate, lithium persulfate or any combinations thereof. The alkaline earth metal peroxygen can be selected from calcium persulfate, magnesium persulfate, or any combinations thereof. In one aspect, the effective concentration of peroxygen ranges from about 1 lb/bbl to about 50 lbs/bbl, preferably from about 4 lb/bbl to about 48 lbs/bbl. In another aspect, for testing purposes, the effective concentration of peroxygen ranges from about 3 g/L to about 143 g/L, preferably from about 11 g/L to about 137 g/L.

Filter cake break or removal time can be controlled by the concentration of the uncoated peroxygen in the brine and also varies with downhole temperature. Increasing the concentration or at higher downhole temperatures results in increased filter cake break or removal.

The variable density brine can be selected from NH₄ Cl, NaCl, KCl, CaCl₂, ZnCl₂, and combinations thereof and, with these chloride brines, can have a density varying within a range of from about 8.3 lbs/gal. to about 12.8 lbs/gal, preferably within a range of from about 8.5 lbs/gal. to about 10.4 lbs/gal.

Downhole temperatures differ according to the depth and location of the formation. The filter cake removal composition of this disclosure can be used at a wide range of downhole temperatures. In one preferred method, the mixture is allowed to remain at the downhole temperatures ranging from 165° F. to 180° F., or from 180° F. to 250° F., or greater than 250° F., for a period of time effective to degrade the filter cake, ranging from about 3.5 to about 48 hours or more depending on the state of well operations at the time. More preferably, the temperature ranges from about 165° F. to 180° F., or between 180° F. and 250° F., and the period of time the mixture remains in contact with the filter cake is at least 4 hours. In another preferred method, the mixture remains at the downhole temperatures ranging from 165° F. to 250° F. and the period of time the mixture remains in contact with the filter cake is at least 4 hours.

The decomposed filter cake can then be flushed away with the acidic filtrate formed by the method of this disclosure. An organic or inorganic acid is commonly known in the art to increase permeability. The method of this disclosure results in acidic conditions, thereby eliminating any need for follow up acid treatments required by conventional processes. The filtrate will be acidic, for example, with a pH from about 0.1 to about 4, preferably from about 0.1 to about 2.5, and more preferably from about 0.1 to about 1, depending on the period of time that the mixture remains in contact with the filter cake.

In an alternative embodiment of this disclosure, the method of removing filter cake from a subterranean borehole involves contacting the filter cake with a mixture of an unencapsulated peroxygen and a surfactant, in a variable density bromide or chloride brine. The brine can be selected from NH₄ Cl, NH₄ Br, NaCl, NaBr, KCl, KBr, CaCl₂, CaBr₂, ZnCl₂, ZnBr₂, or any combinations thereof. In this preferred method, the mixture remains at the downhole temperatures for a period of time effective to degrade the filter cake. The peroxygen is selected from ammonium persulfate, an alkali metal persulfate, an alkaline earth metal persulfate or any combinations thereof. The density can vary within a range of from about 8.3 lbs/gal. to as high as about 18 lbs/gal. if a potassium chloride brine is used.

A preferred composition for a filter cake removal fluid can comprise a solution of an unencapsulated peroxygen and a surfactant, in a brine in which the concentration of uncoated peroxygen effective for filter cake break or removal is at temperatures between 165° F. to 180° F., or between 180° F. and 250° F., or greater than 250° F. Preferably the concentration of uncoated peroxygen ranges from about 1 lb/bbl to about 50 lbs/bbl, more preferably from about 4 lbs/bbl to about 48 lbs/bbl, and most preferably, from 16 lbs/bbl to 48 lbs/bbl. The solution of an unencapsulated peroxygen and a surfactant, in a brine can have a density in a range of about 8.3 lbs/gal to about 12.8 lbs/gal. The uncoated peroxygen is preferably selected from uncoated ammonium persulfate, an uncoated alkali metal persulfate, an uncoated alkaline earth metal persulfate, or any combinations thereof.

Illustrative steps for implementing the method of this disclosure include, for example, installing gravel pack screens and tool assemblies into the borehole. Thereafter, introducing sand in a non-viscosified carrier into the borehole, and introducing a filter cake removal fluid of this disclosure in the well bore, in contact with a subterranean formation containing the hydrocarbons to be produced, for a duration effective to substantially remove the filter cake in the vicinity of the subterranean formation. The filter cake removal fluid preferably comprises a solution of an unencapsulated peroxygen and a surfactant, in a brine having a density in a range of about 8.3 lbs/gal to about 12.8 lbs/gal, and the mixture of uncoated peroxygen and surfactant, is effective for filter cake break or removal at temperatures between 165° F. to 180° F., or between 180° F. and 250° F., or greater than 250° F.

Fluid loss pills can be used to form the filter cake. In an alternative method of removing filter cake from an existing subterranean borehole in which a fluid loss pill is used, the method comprises placing a fluid loss pill into the borehole, the fluid loss pill having a polymer to form a filter cake. In this method, the polymer is selected from a water soluble organic polymer, a water dispersible organic polymer, a water soluble bio-polymer, a water dispersible bio-polymer or any combinations thereof. The filter cake is contacted with a mixture of an unencapsulated peroxygen and a surfactant, in a variable density brine. The peroxygen is preferably selected from ammonium persulfate, alkali metal persulfate, alkaline earth metal persulfate or any combinations thereof. The brine can be selected from NH₄ Cl, NaCl, KCl, CaCl₂, ZnCl₂, or any combinations thereof. In this method, the mixture is allowed to remain at the downhole temperatures ranging from 165° F. to 180° F., or from 180° F. to 250° F., or greater than 250° F., for a period of time effective to degrade the polymer filter cake. Alternatively, the brine is selected from NH₄ Cl, NH₄ Br, NaCl, NaBr, KCl, KBr, CaCl₂, CaBr₂, ZnCl₂, ZnBr₂ or any combinations thereof and the mixture remains at the downhole temperatures also ranging from 165° F. to 180° F., or from 180° F. to 250° F., or greater than 250° F., for a period of time effective to degrade the polymer filter cake.

High permeability, soft sandstone formations, often found in horizontal drilling, generally require some form of barrier for hole stability. Gravel packing is used to improve hole stability in these conditions. During the practice of this disclosure, one method of removing filter cake from a subterranean borehole comprises drilling the borehole while circulating a mud therein which comprises a polymer. The polymer is selected from a water soluble organic polymer, a water dispersible organic polymer, a water soluble bio-polymer, a water dispersible bio-polymer or any combinations thereof.

Following the drilling of a well, when fluid losses are acceptable for the proposed pumping pressures, gravel or sand packing can begin. First, the drill-in fluid is displaced with a first clear fluid, which is otherwise similar to the drilling fluid. The wellbore is maintained in a slightly overbalanced state. Gravel pack screens and tool assemblies are run into the bore. During this stage, it is desirable to maintain the filter cake with as little fluid loss to the production formation as possible. Following displacement of the drilling fluid, the well is gravel packed. In a preferred procedure, the gravel, preferably sized sand, about 20-30 U.S. mesh, is placed into a nonviscosified carrier, such as a brine. Advantageously, the method of this disclosure comprises the simultaneous application of uncoated peroxygen and surfactant, with the gravel pack. Alternatively, at the same time or at a later time, uncoated peroxygen and surfactant can be added to the gravel pack. Alternatively, uncoated peroxygen and surfactant can be added independently of the gravel pack, and also used in systems that do not employ gravel packing.

As the low viscosity fluid cannot transport a significant amount of solids, the sand concentrations are usually from about 60 g/l to 360 g/l and pump rates approach 1 m³/min. The hydrostatic overbalance that arises from the pumping pressure necessary to achieve these rates is desirable since the overbalance holds the filter cake in place. A filter cake removal fluid is then introduced in the wellbore, in contact with a subterranean formation containing the hydrocarbons to be produced, for a duration effective to substantially remove the filter cake in the vicinity of the subterranean formation. Preferably, the filter cake removal fluid comprises a solution of an unencapsulated peroxygen and a surfactant, in a brine having a density in a range of about 8.3 lbs/gal to about 12.8 lbs/gal and effective for degradation at temperatures between 165° F. to 180° F., or between 180° F. to 250° F., or greater than 250° F. The non-viscosified carrier for the sand can comprise the filter cake removal fluid.

In the practice of this disclosure, other additives, such as clay treating additives, pH control agents, lubricants, non-emulsifying agents, iron control agents and the like can be included in the filter cake removal fluid or gravel pack fluid as desired.

In an embodiment, the method of the present disclosure includes applying a liquid treatment fluid to a portion of a wellbore or a portion of a subterranean formation with a composition including an unencapsulated peroxygen (e.g., sodium persulfate) and a surfactant (e.g., nonionic surfactant), optionally an alkali chelate (e.g., a sodium or potassium chelate), and optionally a solvent. The method can include the following: forming or providing the composition, and introducing the composition through a wellbore to apply it to a portion of a wellbore or a portion of a subterranean formation. The liquid treatment fluid can be applied to a portion of a wellbore or subterranean formation by pumping, displacing, or otherwise locating the fluid to a desired location within the wellbore or subterranean formation for treatment, at a rate and pressure that is less than, equal to, or greater than the reservoir hydraulic fracture pressure. The liquid treatment fluid can be applied to a portion of wellbore or subterranean formation as a drilling fluid, as a chemical treatment, in an oil, gas, or water flow stimulation method, for hydraulic fracturing, in an enhanced oil recovery technique, and combinations. The liquid treatment fluid can be applied to a subterranean formation or a hydrocarbon-bearing subterranean formation that is geologically characterized as unconsolidated or consolidated and where the geologic material is, for example, sand, rock, clay, shale, carbonate, dolomite, coal, an argillaceous mineral, a mineral, a hydrocarbon-containing geologic material, or any combinations. For example, the temperature of the geological formation that can be treated using the disclosed composition and methods of this disclosure can range from 50° F. to 250° F., or greater than 250° F.

As part of the methods for application, the composition of this disclosure can be allowed to contact the wellbore or a portion of a wellbore or subterranean formation or hydrocarbon-bearing subterranean formation for a sufficient period of time to degrade filter cake, and increase flow, production, and/or recovery of hydrocarbons. The composition can be allowed to contact a portion of the wellbore, the subterranean formation, a lenticular lens or other types of lens in a formation, the formation cap, the formation base, or a formation interface for a sufficient time, so that the permeability, relative permeability, and/or absolute permeability are increased, causing an increase in the flow, production, and/or recovery of hydrocarbons from the wellbore. Adequate time can be allowed for contact of the disclosed composition. Such a sufficient or adequate time can be, for example, from about 1 minute, 2 minutes, 5 minutes, 15 minutes, 30 minutes, 1 hour, 2 hours, 6 hours, 12 hours, 1 day, 2 days, 4 days, 1 week, 2 weeks, 1 month, 2 months, 3 months, or 6 months to about 2 minutes, 5 minutes, 15 minutes, 30 minutes, 1 hour, 2 hours, 6 hours, 12 hours, 1 day, 2 days, 4 days, 1 week, 2 weeks, 1 month, or 2 months. Shorter contact times are preferred in order to minimize any interruption in flow, production, and/or recovery of hydrocarbons.

Sufficient time can be allowed for the composition to degrade the filter cake. The treatment can cause such targeted areas of a subterranean formation to have an increased permeability, relative permeability, and/or absolute permeability. The composition can be applied with sufficient time allowed for the composition to degrade the filter cake with sufficient action to physically alter, fragment, fracture, crack, pit, and/or create fluid preferential pathways within a portion of the treated subterranean formation, wherein the permeability, relative permeability, and/or absolute permeability is increased. The composition can be applied with sufficient time allowed for the composition to degrade the filter cake with sufficient action to mobilize, release, migrate, realign, and/or redistribute portions of the treated subterranean formation, clays, fines (inorganic and/or organic), sand, precipitates, minerals, and/or individual grains of the treated subterranean formation. These mobilized, released, or otherwise moved components can be removed from the formation and carried into the wellbore along with produced fluids.

In a preferred embodiment, the composition can be applied with sufficient time allowed for the composition to uniformly degrade the filter cake. The method of this disclosure provides effective, controlled, uniform filter cake breakdown under a wide temperature range. Preferably, the method of this disclosure is a single treatment that can achieve filter cake removal and enhanced permeability, thereby providing an increase in the production rates and/or recovery of hydrocarbons.

Preferred embodiments of this disclosure are described below.

The present disclosure provides a first method of removing filter cake from a subterranean borehole. The method comprises: drilling a borehole with a drill-in fluid to form a filter cake, contacting the filter cake with a composition comprising (a) an unencapsulated peroxygen and (b) a surfactant, and allowing the composition to remain downhole at a temperature above 165° F. for a period of time sufficient to degrade the filter cake.

The present disclosure provides the first method in which permeability of a subterranean formation is improved as compared to permeability of a subterranean formation in which a filter cake is contacted with a composition comprising (a) an encapsulated peroxygen, and (b) a surfactant.

The present disclosure provides the first method in which permeability of a subterranean formation is improved as compared to permeability of a subterranean formation in which a filter cake is contacted with a composition comprising (a) an unencapsulated peroxygen, and (b) a surfactant, and the composition can remain downhole at a temperature below 165° F. The improved permeability of the subterranean formation causes an increase in the production rates and/or recovery of hydrocarbons.

The present disclosure provides the first method in which the peroxygen chemically breaks down the filter cake via a direct oxidation pathway or via a free radical pathway.

The present disclosure provides the first method which further comprises removing the degraded filter cake from the subterranean borehole.

The present disclosure provides the first method in which the treatment generates acidic conditions.

The present disclosure provides the first method in which the composition further comprises a variable density brine.

The present disclosure provides the first method in which at least one component of the composition is mixed with fresh water, brine water, formation water with potassium chloride or other salts added, or combinations thereof, prior to introduction into the subterranean borehole.

The present disclosure provides the first method in which the unencapsulated peroxygen is selected from the group consisting of unencapsulated hydrogen peroxide, an unencapsulated source of hydrogen peroxide, unencapsulated sodium persulfate, unencapsulated potassium persulfate, unencapsulated ammonium persulfate, or any combinations thereof.

The present disclosure provides the first method in which the peroxygen from the unencapsulated peroxygen decomposes from a direct reduction reaction, a surface catalyzed reaction, and/or a free radical decomposition reaction.

The present disclosure provides the first method in which the surfactant is nonionic.

The present disclosure provides the first method in which the surfactant is selected from the following group: an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, or any combinations thereof.

The present disclosure provides the first method in which the surfactant comprises a nonionic surfactant is selected from the following group: a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, or a combinations thereof.

The present disclosure provides the first method in which the surfactant comprises a nonionic surfactant selected from the following group: an ethoxylated coco fatty acid, an ethoxylated coco fatty ester, an ethoxylated cocoamide, an ethoxylated castor oil, a monococoate, or any combinations thereof. The ethoxylated coco fatty acid is a polyethylene glycol (PEG) coco fatty acid having a range of about 5 to about 40 PEG groups, and a Hydrophile-Lipophile Balance (HLB) range from about 10 to about 19; the ethoxylated castor oil is a polyethylene glycol (PEG) castor oil having a range of about 2.5 to about 40 PEG groups, and a Hydrophile-Lipophile Balance (HLB) range from about 2.1 to about 16; the ethoxylated cocoamide is a polyethylene glycol (PEG) cocamide having a range of about 2 to about 20 PEG groups, and a Hydrophile-Lipophile Balance (HLB) range from about 2 to about 19.

The present disclosure provides the first method in which the surfactant comprises a sorbitan ester selected from the following group: sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

The present disclosure provides the first method in which the surfactant comprises an ethoxylated sorbitan ester. The ethoxylated sorbitan ester is selected from the following group: a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

The present disclosure provides the first method in which the surfactant is present in the composition, when the composition is introduced into the wellbore or subterranean formation, in an amount from about 0.01 to about 50 percent by weight, based on the total weight of the composition.

The present disclosure provides the first method in which the composition further comprises a chelate. The chelate is selected from the following group: a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), or any combinations thereof.

The present disclosure provides the first method in which the composition further comprises a solvent. The solvent is selected from the following group: a terpene, methyl soyate, ethyl lactate, methyl lactate, ethyl acetate, or any combinations thereof.

The present disclosure provides the first method in which the unencapsulated peroxygen and surfactant are added simultaneously or sequentially to the composition.

The present disclosure provides the first method in which the composition is applied to the subterranean borehole as, or in combination with, a drilling fluid, treatment fluid, stimulation fluid, fracturing fluid, a fluid used in an enhanced oil recovery technique, or a combination thereof.

The present disclosure provides the first method which further comprises: allowing the components to contact blockage or damage in the subterranean borehole, so that the damage or blockage is altered, removed, degraded, and/or dissolved, so that a permeability, a relative permeability, and/or an absolute permeability of the subterranean formation is increased, causing an increase in the production rates and/or recovery of hydrocarbons.

The present disclosure provides the first method in which the unencapsulated peroxygen is present in the composition, when the composition is introduced into the wellbore or subterranean formation, in an amount from about 0.01 to about 50 percent by weight, based on the total weight of the composition.

The present disclosure provides the first method in which the surfactant is present in the composition, when the composition is introduced into the wellbore or subterranean formation, in an amount from about 0.01 to about 50 percent by weight, based on the total weight of the composition.

The present disclosure provides a second method of removing filter cake from a subterranean borehole. The method comprises: drilling a borehole with a drill-in fluid to form a filter cake; contacting the filter cake with a composition comprising (a) an unencapsulated peroxygen and (b) a surfactant; and allowing the composition to remain downhole at a temperature from about 165° F. to about 250° F. and for a period of time sufficient to degrade the filter cake.

The present disclosure provides the second method in which permeability of a subterranean formation is improved as compared to permeability of a subterranean formation in which a filter cake is contacted with a composition comprising (a) an encapsulated peroxygen, and (b) a surfactant.

The present disclosure provides the second method in which permeability of a subterranean formation is improved as compared to permeability of a subterranean formation in which a filter cake is contacted with a composition comprising (a) an unencapsulated peroxygen, and (b) a surfactant, and the composition can remain downhole at a temperature below 165° F. The improved permeability of the subterranean formation causes an increase in the production rates and/or recovery of hydrocarbons.

The present disclosure provides the second method in which the peroxygen chemically breaks down the filter cake via a direct oxidation pathway or via a free radical pathway.

The present disclosure provides the second method which further comprises removing the degraded filter cake from the subterranean borehole.

The present disclosure provides the second method in which the treatment generates acidic conditions.

The present disclosure provides the second method in which the composition further comprises a variable density brine.

The present disclosure provides the second method in which at least one component of the composition is mixed with fresh water, brine water, formation water with potassium chloride or other salts added, or combinations thereof, prior to introduction into the subterranean borehole.

The present disclosure provides the second method in which the unencapsulated peroxygen is selected from the following group: unencapsulated hydrogen peroxide, an unencapsulated source of hydrogen peroxide, unencapsulated sodium persulfate, unencapsulated potassium persulfate, unencapsulated ammonium persulfate, or any combinations thereof.

The present disclosure provides the second method in which peroxygen from the unencapsulated peroxygen decomposes from a direct reduction reaction, a surface catalyzed reaction, and/or a free radical decomposition reaction.

The present disclosure provides the second method in which the surfactant is nonionic.

The present disclosure provides the second method in which the surfactant is selected from the following group: an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, or any combinations thereof.

The present disclosure provides the second method in which the surfactant comprises a nonionic surfactant selected from the following group: a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, or any combinations thereof.

The present disclosure provides the second method in which the surfactant comprises a nonionic surfactant selected from the following group: an ethoxylated coco fatty acid, an ethoxylated coco fatty ester, an ethoxylated cocoamide, an ethoxylated castor oil, a monococoate, or any combinations thereof. The ethoxylated coco fatty acid is a polyethylene glycol (PEG) coco fatty acid having a range of about 5 to about 40 PEG groups, and a Hydrophile-Lipophile Balance (HLB) range from about 10 to about 19; the ethoxylated castor oil is a polyethylene glycol (PEG) castor oil having a range of about 2.5 to about 40 PEG groups, and a Hydrophile-Lipophile Balance (HLB) range from about 2.1 to about 16; the ethoxylated cocoamide is a polyethylene glycol (PEG) cocamide having a range of about 2 to about 20 PEG groups, and a Hydrophile-Lipophile Balance (HLB) range from about 2 to about 19.

The present disclosure provides the second method in which the surfactant comprises a sorbitan ester selected from the following group: sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

The present disclosure provides the second method in which the surfactant comprises an ethoxylated sorbitan ester selected from the following group: a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

The present disclosure provides the second method in which the surfactant is present in the composition, when the composition is introduced into the wellbore or subterranean formation, in an amount from about 0.01 to about 50 percent by weight, based on the total weight of the composition.

The present disclosure provides the second method in which the composition further comprises a chelate. The chelate is selected from the following group: a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), or any combinations thereof.

The present disclosure provides the second method in which the composition further comprises a solvent. The solvent is selected from the following group: a terpene, methyl soyate, ethyl lactate, methyl lactate, ethyl acetate, or any combinations thereof.

The present disclosure provides the second method in which the composition is applied to the subterranean borehole as, or in combination with, a drilling fluid, treatment fluid, stimulation fluid, fracturing fluid, a fluid used in an enhanced oil recovery technique, or a combination thereof.

The present disclosure provides the second method which further comprises: allowing the components to contact blockage or damage in the subterranean borehole, so that the damage or blockage is altered, removed, degraded, and/or dissolved, so that a permeability, a relative permeability, and/or an absolute permeability of the subterranean formation is increased, causing an increase in the production rates and/or recovery of hydrocarbons.

The present disclosure provides the second method in which the unencapsulated peroxygen is present in the composition, when the composition is introduced into the wellbore or subterranean formation, in an amount from about 0.01 to about 50 percent by weight, based on the total weight of the composition.

The present disclosure provides the second method in which wherein the surfactant is present in the composition, when the composition is introduced into the wellbore or subterranean formation, in an amount from about 0.01 to about 50 percent by weight, based on the total weight of the composition.

The present disclosure provides a composition for removing filter cake from a subterranean borehole. The composition comprises: (a) an unencapsulated peroxygen and (b) a surfactant. The preferred unencapsulated peroxygen is sodium persulfate, and the preferred surfactant is a nonionic surfactant.

The present disclosure provides the composition in which permeability of a subterranean formation is improved as compared to permeability of a subterranean formation in which a filter cake is contacted with a composition comprising (a) an encapsulated peroxygen, and (b) a surfactant.

The present disclosure provides the composition in which permeability of a subterranean formation is improved as compared to permeability of a subterranean formation in which a filter cake is contacted with a composition comprising (a) an unencapsulated peroxygen, and (b) a surfactant, and the composition can remain downhole at a temperature below 165° F.

The present disclosure provides the composition in which the improved permeability of the subterranean formation causes an increase in the production rates and/or recovery of hydrocarbons.

The present disclosure provides the composition in which the improved permeability of the subterranean formation causes an increase in the production rates and/or recovery of hydrocarbons.

The present disclosure provides the composition in which the peroxygen chemically breaks down the filter cake via a direct oxidation pathway or via a free radical pathway.

The present disclosure provides the composition in which the treatment generates acidic conditions.

The present disclosure provides the composition which further comprises a variable density brine.

The present disclosure provides the composition in which at least one component of the composition is mixed with fresh water, brine water, formation water with potassium chloride or other salts added, or combinations thereof, prior to introduction into the subterranean borehole.

The present disclosure provides the composition in which the unencapsulated peroxygen is selected from the group consisting of unencapsulated hydrogen peroxide, an unencapsulated source of hydrogen peroxide, unencapsulated sodium persulfate, unencapsulated potassium persulfate, unencapsulated ammonium persulfate, or any combinations thereof.

The present disclosure provides the composition in which the peroxygen from the unencapsulated peroxygen decomposes from a direct reduction reaction, a surface catalyzed reaction, and/or a free radical decomposition reaction.

The present disclosure provides the composition in which the surfactant is nonionic.

The present disclosure provides the composition in which the surfactant is selected from the following group: an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, or any combinations thereof.

The present disclosure provides the composition in which the surfactant comprises a nonionic surfactant selected from the following group: a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, or a combinations thereof.

The present disclosure provides the composition in which the surfactant comprises a nonionic surfactant selected from the following group: an ethoxylated coco fatty acid, an ethoxylated coco fatty ester, an ethoxylated cocoamide, an ethoxylated castor oil, a monococoate, or any combinations thereof. The ethoxylated coco fatty acid is a polyethylene glycol (PEG) coco fatty acid having a range of about 5 to about 40 PEG groups, and a Hydrophile-Lipophile Balance (HLB) range from about 10 to about 19; the ethoxylated castor oil is a polyethylene glycol (PEG) castor oil having a range of about 2.5 to about 40 PEG groups, and a Hydrophile-Lipophile Balance (HLB) range from about 2.1 to about 16; the ethoxylated cocoamide is a polyethylene glycol (PEG) cocamide having a range of about 2 to about 20 PEG groups, and a Hydrophile-Lipophile Balance (HLB) range from about 2 to about 19.

The present disclosure provides the composition in which the surfactant comprises a sorbitan ester selected from the following group: sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

The present disclosure provides the composition in which the surfactant comprises an ethoxylated sorbitan ester. The ethoxylated sorbitan ester is selected from the following group: a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

The present disclosure provides the composition in which the surfactant is present in the composition, when the composition is introduced into the subterranean borehole, in an amount from about 0.01 to about 50 percent by weight, based on the total weight of the composition.

The present disclosure provides the composition which further comprises a chelate. The chelate is selected from the following group: a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), or any combinations thereof.

The present disclosure provides the composition which further comprises a solvent. The solvent is selected from the following group: a terpene, methyl soyate, ethyl lactate, methyl lactate, ethyl acetate, or any combinations thereof.

The present disclosure provides the composition which is applied to the subterranean borehole as, or in combination with, a drilling fluid, treatment fluid, stimulation fluid, fracturing fluid, a fluid used in an enhanced oil recovery technique, or a combination thereof.

The present disclosure provides the composition which is allowed to contact blockage or damage in the subterranean borehole, so that the damage or blockage is altered, removed, degraded, and/or dissolved, so that a permeability, a relative permeability, and/or an absolute permeability of the subterranean borehole is increased, causing an increase in the production rates and/or recovery of hydrocarbons.

The present disclosure provides the composition in which the unencapsulated peroxygen is present in the composition, when the composition is introduced into the subterranean borehole, in an amount from about 0.01 to about 50 percent by weight, based on the total weight of the composition.

The present disclosure provides the composition in which the surfactant is present in the composition, when the composition is introduced into the subterranean borehole, in an amount from about 0.01 to about 50 percent by weight, based on the total weight of the composition.

The present disclosure also provides a third method which is a one-step method for degrading filter cake. The method comprises: contacting the filter cake with a composition comprising (a) an unencapsulated peroxygen and (b) a surfactant; and allowing the composition to remain in contact with the filter cake at a temperature above 165° F. for a period of time sufficient to degrade the filter cake; wherein the method generates acidic conditions.

The present disclosure provides the third method in which permeability of a subterranean formation is improved as compared to permeability of a subterranean formation in which a filter cake is contacted with a composition comprising (a) an encapsulated peroxygen, and (b) a surfactant.

The present disclosure provides the third method in which permeability of a subterranean formation is improved as compared to permeability of a subterranean formation in which a filter cake is contacted with a composition comprising (a) an unencapsulated peroxygen, and (b) a surfactant, and the composition can remain downhole at a temperature below 165° F. The present disclosure provides the third method in which the improved permeability of the subterranean formation causes an increase in the production rates and/or recovery of hydrocarbons.

The present disclosure provides the third method in which the peroxygen chemically breaks down the filter cake via a direct oxidation pathway or via a free radical pathway.

The present disclosure provides the third method which also comprises removing the degraded filter cake from the subterranean borehole.

The present disclosure provides the third method in which the composition further comprises a variable density brine.

The present disclosure provides the third method in which at least one component of the composition is mixed with fresh water, brine water, formation water with potassium chloride or other salts added, or combinations thereof, prior to introduction into the subterranean borehole.

The present disclosure provides the third method in which the unencapsulated peroxygen is selected from the group consisting of unencapsulated hydrogen peroxide, an unencapsulated source of hydrogen peroxide, unencapsulated sodium persulfate, unencapsulated potassium persulfate, unencapsulated ammonium persulfate, or any combinations thereof.

The present disclosure provides the third method in which the peroxygen from the unencapsulated peroxygen decomposes from a direct reduction reaction, a surface catalyzed reaction, and/or a free radical decomposition reaction.

The present disclosure provides the third method in which the surfactant is nonionic.

The present disclosure provides the third method in which the surfactant is selected from the following group: an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, or any combinations thereof.

The present disclosure provides the third method in which the surfactant comprises a nonionic surfactant is selected from the following group: a fatty alcohol ethoxylate, a fatty acid ethoxylate, a fatty acid ester, a fatty acid methyl ester ethoxylate, an alkyl polyglucoside, a polyalcohol ethoxylate, a soy alkyltrimethyl ammonium chloride, a monococoate, or a combinations thereof.

The present disclosure provides the third method in which the surfactant comprises a nonionic surfactant selected from the following group: an ethoxylated coco fatty acid, an ethoxylated coco fatty ester, an ethoxylated cocoamide, an ethoxylated castor oil, a monococoate, or any combinations thereof. The ethoxylated coco fatty acid is a polyethylene glycol (PEG) coco fatty acid having a range of about 5 to about 40 PEG groups, and a Hydrophile-Lipophile Balance (HLB) range from about 10 to about 19; the ethoxylated castor oil is a polyethylene glycol (PEG) castor oil having a range of about 2.5 to about 40 PEG groups, and a Hydrophile-Lipophile Balance (HLB) range from about 2.1 to about 16; the ethoxylated cocoamide is a polyethylene glycol (PEG) cocamide having a range of about 2 to about 20 PEG groups, and a Hydrophile-Lipophile Balance (HLB) range from about 2 to about 19.

The present disclosure provides the third method in which the surfactant comprises a sorbitan ester selected from the following group: sorbitan monooleate having a Hydrophile-Lipophile Balance (HLB) range from about 2.8 to about 8.8; sorbitan monolaurate having a Hydrophile-Lipophile Balance (HLB) range from about 4.6 to about 12.6; sorbitan monopalmitate having a Hydrophile-Lipophile Balance (HLB) range from about 2.5 to about 10.5; and sorbitan monostearate having a Hydrophile-Lipophile Balance (HLB) range from about 2.7 to about 8.7.

The present disclosure provides the third method in which the surfactant comprises an ethoxylated sorbitan ester. The ethoxylated sorbitan ester is selected from the following group: a polyethylene glycol (PEG) sorbitan monooleate having a range of about 2 to about 40 PEG groups, and having a Hydrophile-Lipophile Balance (HLB) range from about 10 to about 20; a polyethylene glycol (PEG) sorbitan monolaurate having a range of about 2 to about 40 PEG groups, and having a Hydrophile-Lipophile Balance (HLB) range from about 10 to about 20; a polyethylene glycol (PEG) sorbitan monopalmitate having a range of about 2 to about 40 PEG groups, and having a Hydrophile-Lipophile Balance (HLB) range from about 10 to about 20; and a polyethylene glycol (PEG) sorbitan monostearate having a range of about 2 to about 40 PEG groups, and having a Hydrophile-Lipophile Balance (HLB) range from about 10 to about 20.

The present disclosure provides the third method in which the surfactant is present in the composition, when the composition is introduced into the wellbore or subterranean formation, in an amount from about 0.01 to about 50 percent by weight, based on the total weight of the composition.

The present disclosure provides the third method in which the composition further comprises a chelate. The chelate is selected from the following group: a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), or any combinations thereof.

The present disclosure provides the third method in which the composition further comprises a solvent. The solvent is selected from the following group: a terpene, methyl soyate, ethyl lactate, methyl lactate, ethyl acetate, or any combinations thereof.

The present disclosure provides the third method in which the unencapsulated peroxygen and surfactant are added simultaneously or sequentially to the composition.

The present disclosure provides the third method in which the composition is applied to a subterranean borehole as, or in combination with, a drilling fluid, treatment fluid, stimulation fluid, fracturing fluid, a fluid used in an enhanced oil recovery technique, or a combination thereof.

The present disclosure provides the third method which further comprises: allowing the components to contact blockage or damage in the subterranean borehole, so that the damage or blockage is altered, removed, degraded, and/or dissolved, so that a permeability, a relative permeability, and/or an absolute permeability of the subterranean formation is increased, causing an increase in the production rates and/or recovery of hydrocarbons.

The present disclosure provides the third method in which the unencapsulated peroxygen is present in the composition, when the composition is introduced into the wellbore or subterranean formation, in an amount from about 0.01 to about 50 percent by weight, based on the total weight of the composition.

The present disclosure provides the third method in which the surfactant is present in the composition, when the composition is introduced into the wellbore or subterranean formation, in an amount from about 0.01 to about 50 percent by weight, based on the total weight of the composition.

The terms “comprises” or “comprising” are interpreted as specifying the presence of the stated features, integers, steps or components, but not precluding the presence of one or more other features, integers, steps or components or groups thereof. The term “in” means in or on or within the object of the prepositional phrase.

It should be understood that various alternatives, combinations and modifications of the present disclosure could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The following examples are provided to offer additional description of the compositions and methods disclosed and claimed in this patent. These are exemplary only, and are not intended to limit the disclosure in any aspect. All proportions and percentages set out herein are by weight unless the contrary is stated.

### Example 1

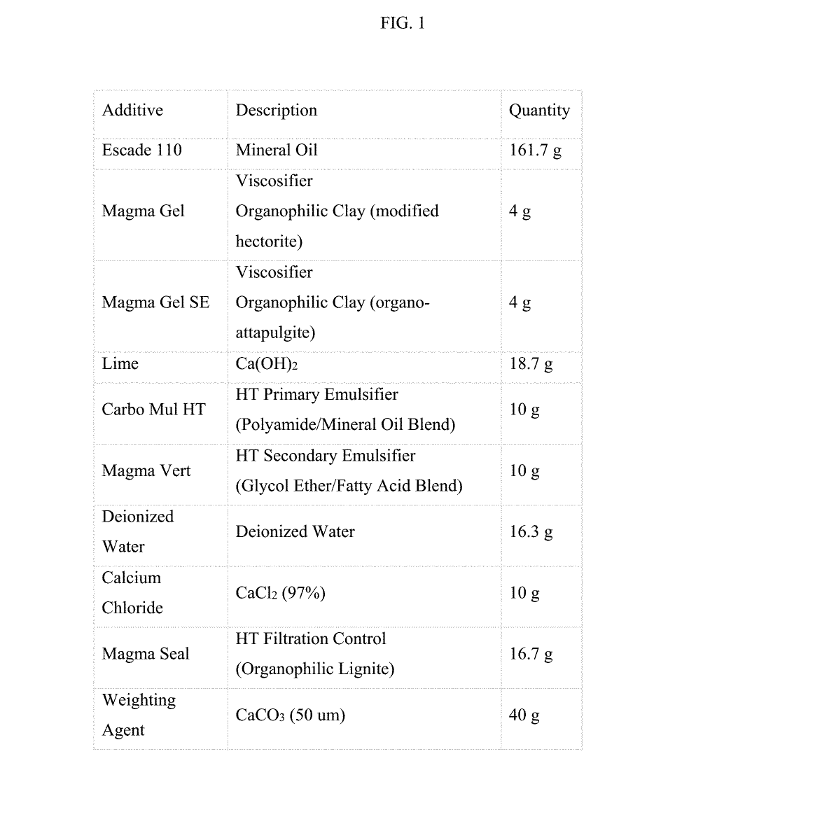

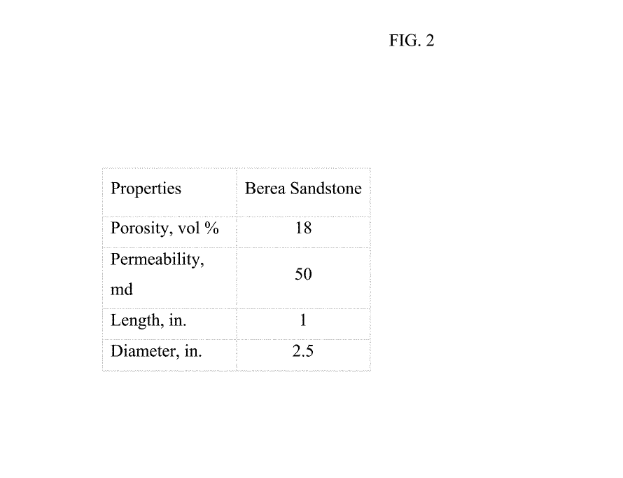

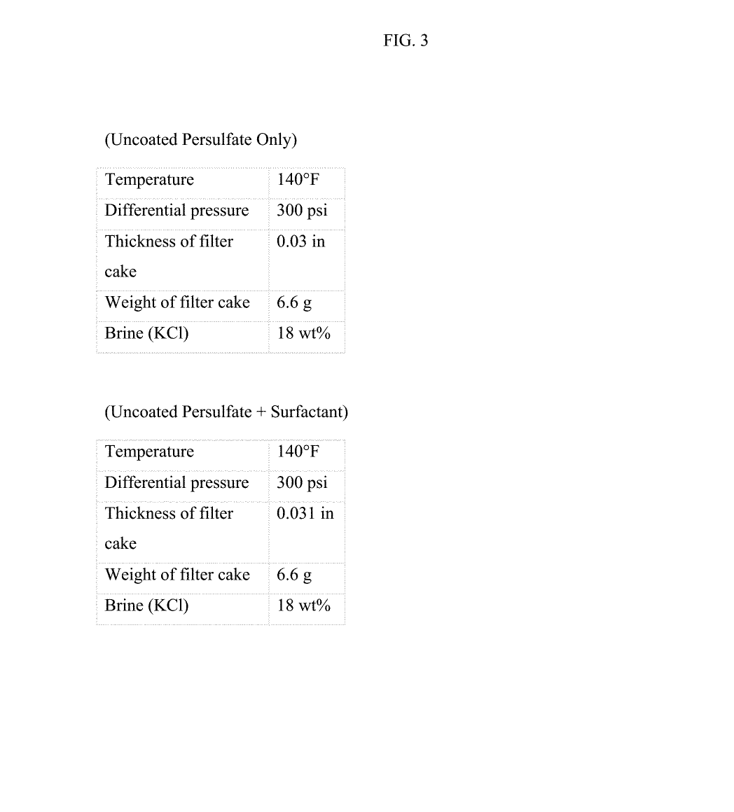

Optimized oil-based drilling mud was prepared. The mud ingredients and amounts thereof are set forth in FIG. 1. A filter cake was formed using a multi-mixer and a high temperature high pressure (HTHP) filtration press. A treatment solution was prepared in a KCl brine solution. The filter cake was soaked over 4 hours, 8 hours, 20 hours, and 42 hours. Filtrate solution was analyzed for ion concentrations. By measuring the filtration rate before and after each test, the permeability ratio (k_{f}/kᵢ) was determined. The final permeability is designated k_{f}. The initial permeability is designated kᵢ. The properties of a core sample are given in FIG. 2.

### Example 2

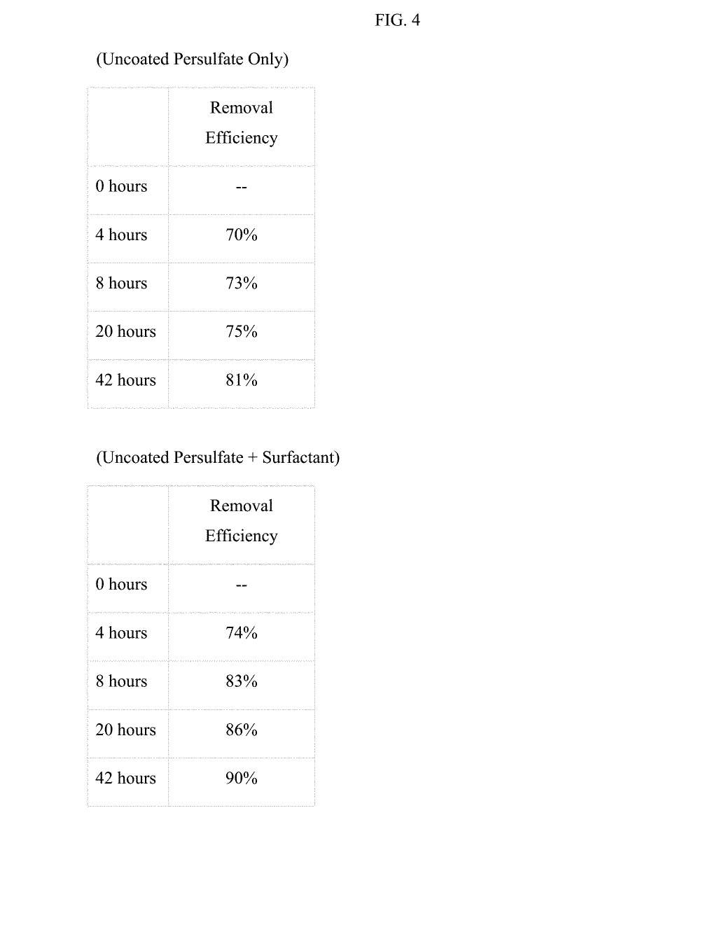

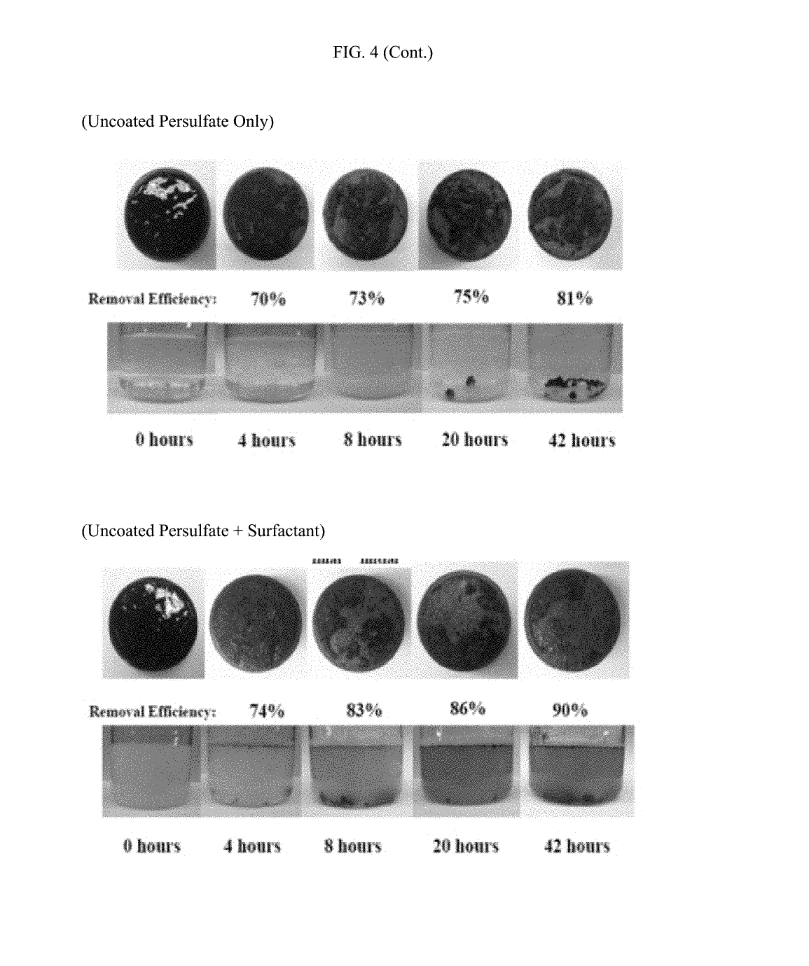

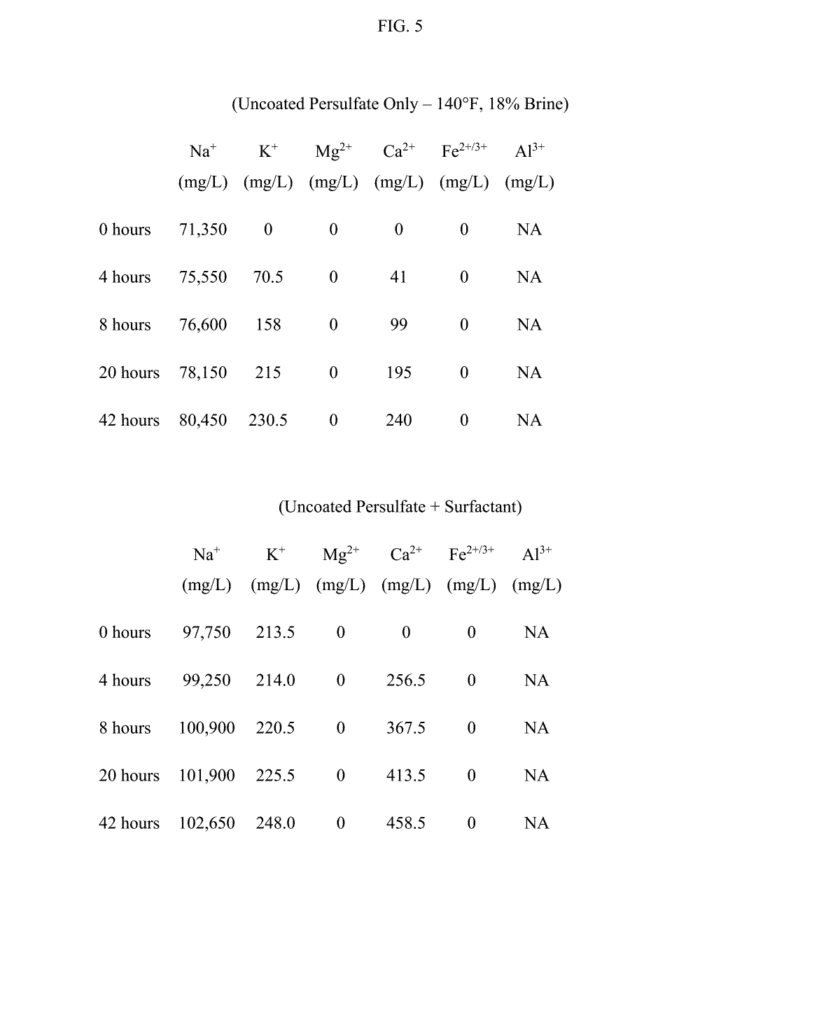

A blend composition containing a surfactant (i.e., ethoxylated coco fatty) and an uncoated persulfate (i.e., sodium persulfate) was prepared. A comparative blend composition containing an uncoated persulfate (i.e., sodium persulfate) and no surfactant was also prepared. The blends were used in breaking of a filter cake formed in Example 1 and creation of acidic conditions. The conditions used in breaking of the filter cake are given in FIG. 3. The filter cake removal results are given in FIG. 4. Photographs of the filter cake removal results are also given in FIG. 4. A filtrate analysis for Na⁺, K⁺, Mg²⁺, Ca²⁺, Fe^{2+/3+} is given in FIG. 5. Filter cake was treated at 140° F. in 18 wt % KCl brine. The permeability ratio (k_{f}/kᵢ) was determined to be 0.93 for the blend composition, and 0.90 for the comparative blend composition, indicating no improvement in permeability for both blends.

### Example 3

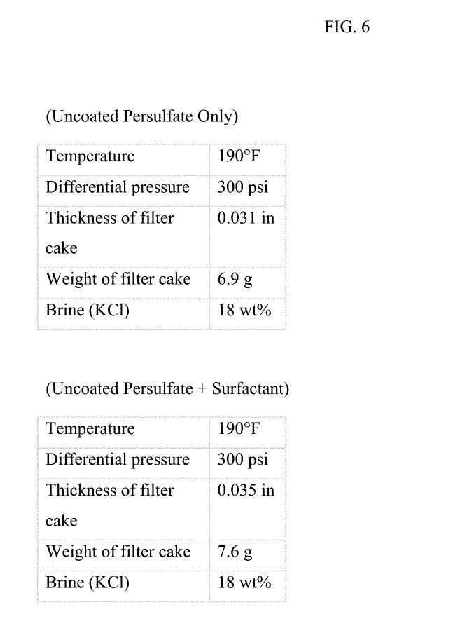

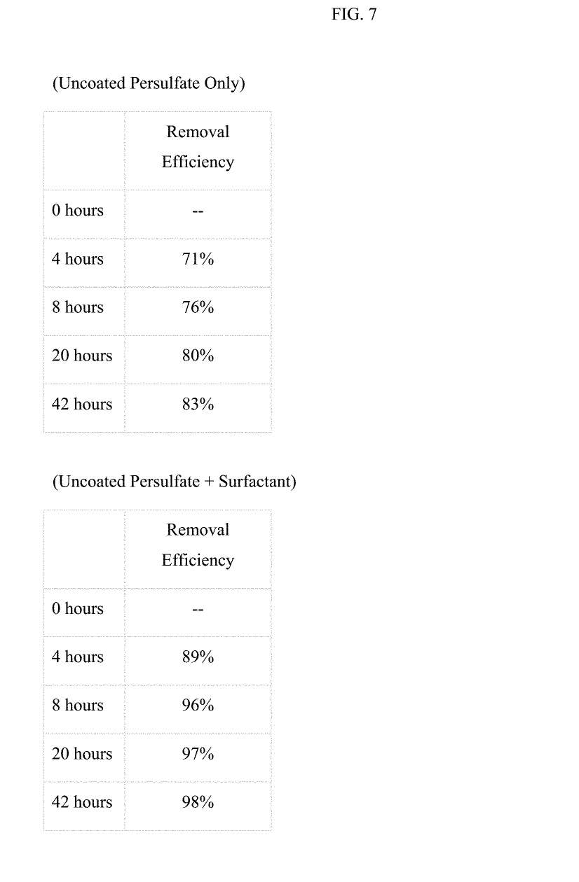

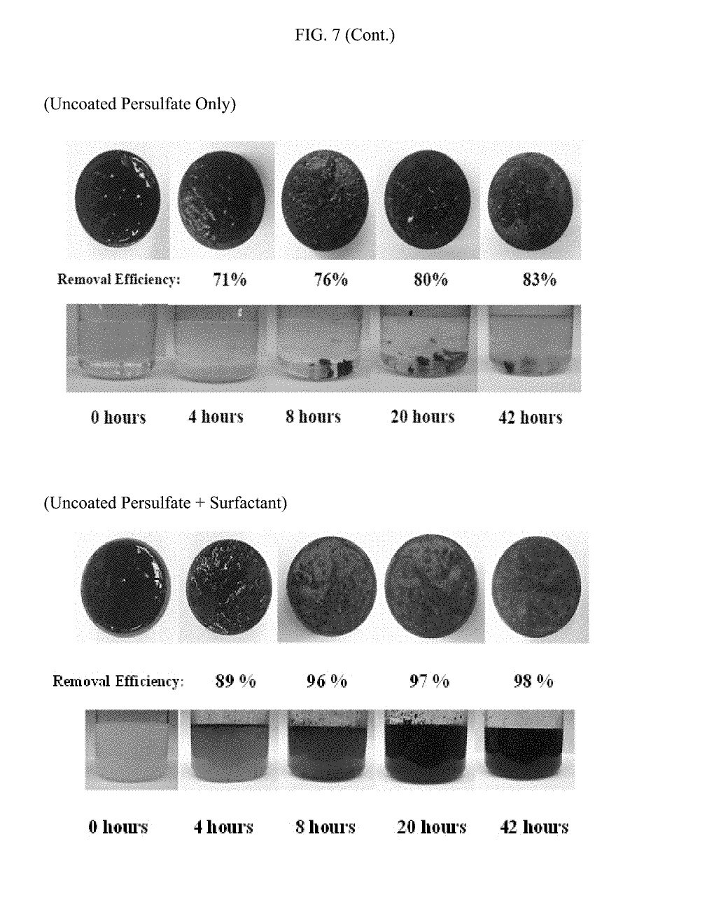

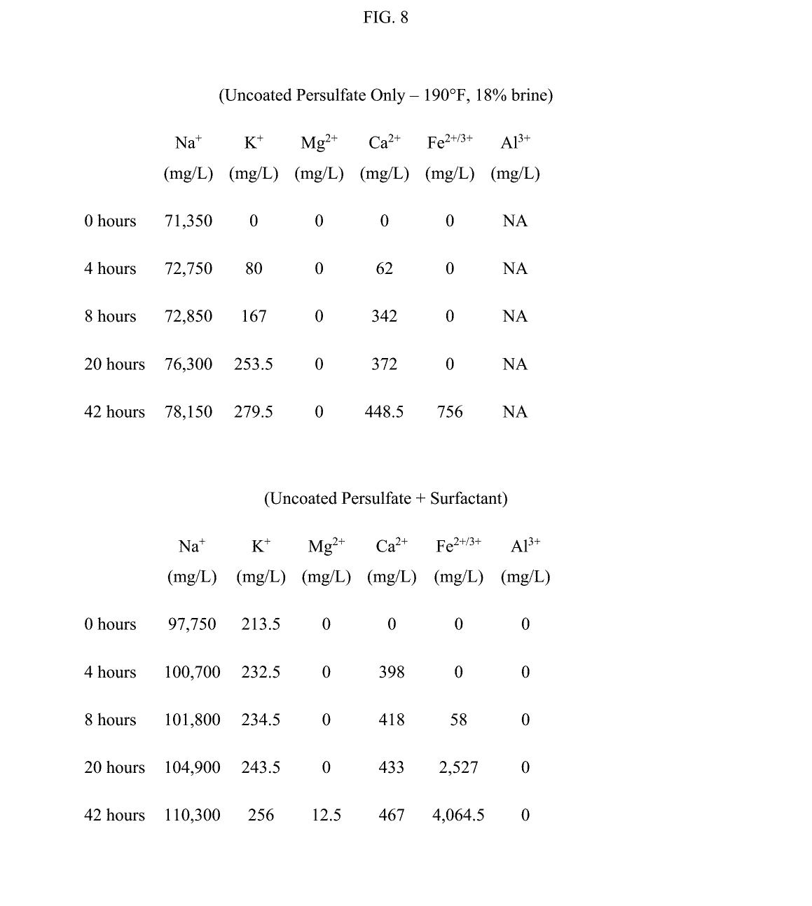

A blend composition containing a surfactant (i.e., ethoxylated coco fatty) and an uncoated persulfate (i.e., sodium persulfate) was prepared. A comparative blend composition containing an uncoated persulfate (i.e., sodium persulfate) and no surfactant was also prepared. The blends were used in breaking of a filter cake formed in Example 1 and creation of acidic conditions. The conditions used in breaking of the filter cake are given in FIG. 6. The filter cake removal results are given in FIG. 7. Photographs of the filter cake removal results are also given in FIG. 7. A filtrate analysis for Na⁺, Ca⁺ and Fe^{2+/3+} is given in FIG. 8. Filter cake was successfully treated with the blend composition at 190° F., 18% brine within 8 hours, where 96% of the filter cake was removed. The permeability ratio (k_{f}/kᵢ) was determined to be 0.91 for the comparative blend composition, indicating no improvement in permeability. The permeability ratio (k_{f}/kᵢ) was determined to be 1.2 for the blend composition, indicating improved permeability.

### Example 4

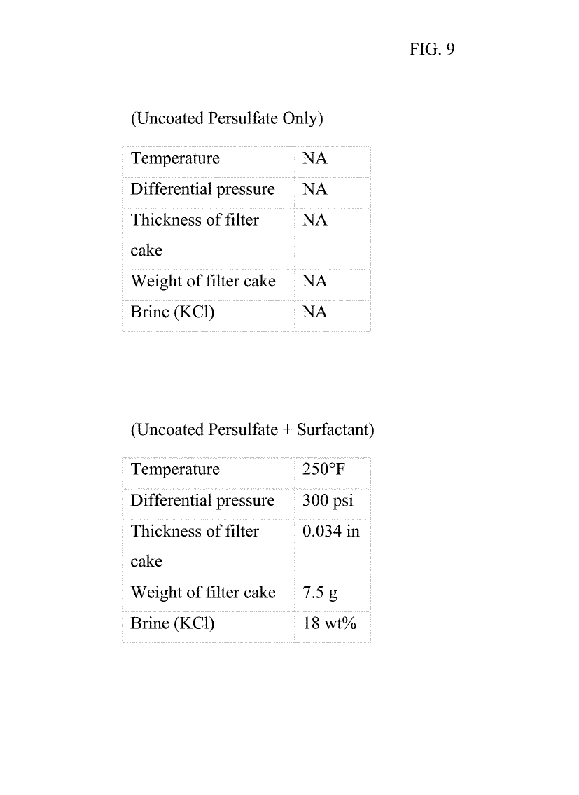

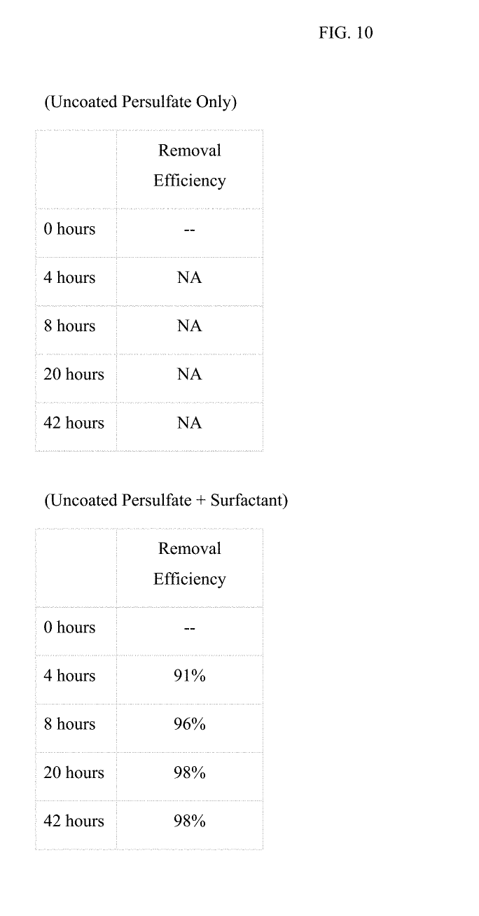

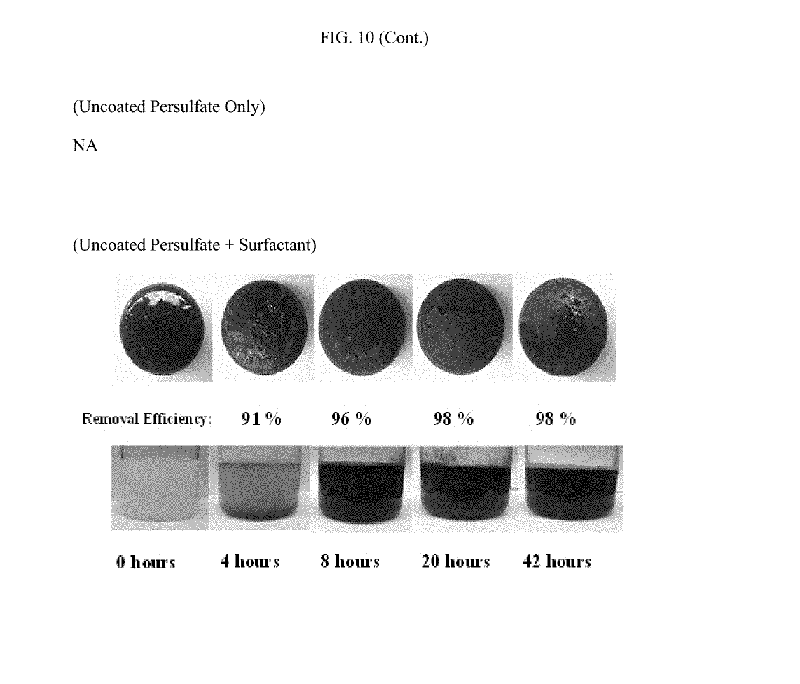

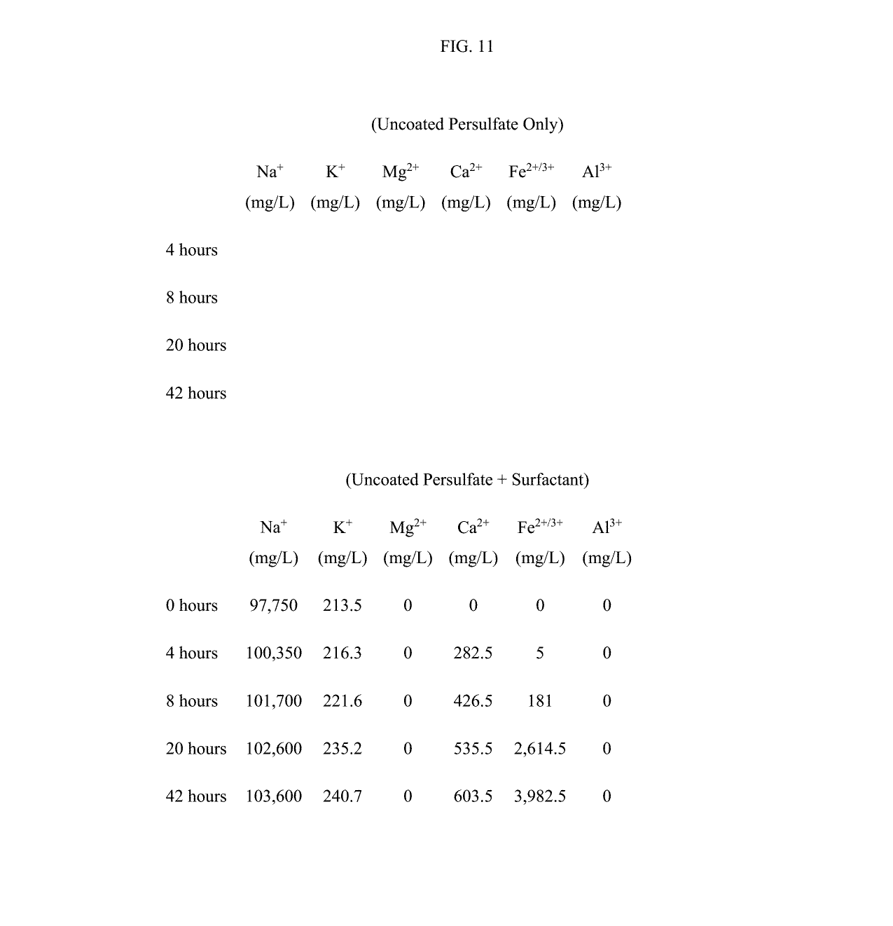

A blend composition containing a surfactant (i.e., ethoxylated coco fatty) and an uncoated persulfate (i.e., sodium persulfate) was prepared. A comparative blend composition containing an uncoated persulfate (i.e., sodium persulfate) and no surfactant was also prepared. The blends were used in breaking of a filter cake formed in Example 1 and creation of acidic conditions. The conditions used in breaking of the filter cake are given in FIG. 9. The filter cake removal results are given in FIG. 10. Photographs of the filter cake removal results are also given in FIG. 10. A filtrate analysis for Na⁺, K⁺, Mg²⁺, Ca²⁺, Fe^{2+/3+} and Al³⁺ is given in FIG. 11. Filter cake was successfully treated with the blend composition at 250° F., 18% brine within 8 hours, where 96% of the filter cake was removed. The permeability ratio (k_{f}/kᵢ) was determined to be for the comparative blend composition, indicating no improvement in permeability. The permeability ratio (k_{f}/kᵢ) was determined to be 1.17 for the blend composition, indicating improved permeability.

What is claimed is:

1. A method of removing filter cake from a subterranean borehole, said method comprising:
drilling a borehole with a drill-in fluid to form a filter cake;
contacting the filter cake with a composition comprising (a) an unencapsulated peroxygen, and (b) a surfactant; and
allowing the composition to remain downhole at a temperature above 165° F. for a period of time sufficient to degrade the filter cake.

2. The method of claim 1, wherein the peroxygen chemically breaks down the filter cake via a direct oxidation pathway or via a free radical pathway.

3. The method of claim 1, wherein the treatment generates acidic conditions.

4. The method of claim 1, wherein at least one component of the composition is mixed with fresh water, brine water, formation water with potassium chloride or other salts added, or combinations thereof, prior to introduction into the subterranean borehole.

5. The method of claim 1, wherein the unencapsulated peroxygen is selected from the group consisting of unencapsulated hydrogen peroxide, an unencapsulated source of hydrogen peroxide, unencapsulated sodium persulfate, unencapsulated potassium persulfate, unencapsulated ammonium persulfate, and any combinations thereof.

6. The method of claim 1, wherein the surfactant is selected from the group consisting of an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, and any combinations thereof.

7. The method of claim 1, further comprising a chelate, wherein the chelate is selected from the group consisting of a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), and any combinations thereof.

8. The method of claim 1, further comprising a solvent, wherein the solvent is selected from the group consisting of a terpene, methyl soyate, ethyl lactate, methyl lactate, ethyl acetate, and any combinations thereof.

9. The method of claim 1, wherein the composition is applied to the subterranean borehole as, or in combination with, a drilling fluid, treatment fluid, stimulation fluid, fracturing fluid, a fluid used in an enhanced oil recovery technique, or any combinations thereof.

10. The method of claim 1, further comprising: allowing the composition to contact blockage or damage in the subterranean borehole, so that the damage or blockage is altered, removed, degraded, and/or dissolved, so that a permeability, a relative permeability, and/or an absolute permeability of a subterranean formation wall is increased, causing an increase in the production rates and/or recovery of hydrocarbons.

11. The method of claim 1, wherein the unencapsulated peroxygen is present in the composition, when the composition is introduced into the wellbore or subterranean formation, in an amount from about 0.01 to about 50 percent by weight, based on the total weight of the composition; and wherein the surfactant is present in the composition, when the composition is introduced into the wellbore or subterranean formation, in an amount from about 0.01 to about 50 percent by weight, based on the total weight of the composition.

12. A composition for removing filter cake from a subterranean borehole, said composition comprising: (a) an unencapsulated peroxygen; and (b) a nonionic surfactant, wherein the unencapsulated peroxygen and the surfactant are present in an amount sufficient to allow the composition to remain downhole at a temperature above 165° F. for a period of time sufficient to degrade the filter cake.

13. The composition of claim 12, wherein the peroxygen chemically breaks down the filter cake via a direct oxidation pathway or via a free radical pathway.

14. The composition of claim 12, wherein the treatment generates acidic conditions.

15. The composition of claim 12, wherein the composition further comprises a variable density brine.

16. The composition of claim 12, wherein the unencapsulated peroxygen is selected from the group consisting of unencapsulated hydrogen peroxide, an unencapsulated source of hydrogen peroxide, unencapsulated sodium persulfate, unencapsulated potassium persulfate, unencapsulated ammonium persulfate, and any combinations thereof.

17. The composition of claim 12, wherein the surfactant is selected from the group consisting of an ethoxylated plant oil based surfactant, a fatty alcohol ethoxylate, a fatty acid ethoxylate, a fatty acid amide ethoxylate, a fatty acid ester, a fatty acid methyl ester ethoxylate, an alkyl polyglucoside, a polyalcohol ethoxylate, a sorbitan ester, a soy alkyltrimethyl ammonium chloride, an ethoxylated coco fatty acid, an ethoxylated coco fatty ester, an ethoxylated cocoamide, an ethoxylated castor oil, and any combinations thereof.

18. The composition of claim 12, further comprising a chelate, wherein the chelate is selected from the group consisting of a mono-, di-, tri- or tetra-sodium ethylenediaminetetraacetic acid (EDTA), a mono-, di-, tri- or tetra-potassium ethylenediaminetetraacetic acid (EDTA), sodium ethylenediamine-N,N′-disuccinic acid (EDDS), and any combinations thereof.

19. The composition of claim 12, further comprising a solvent, wherein the solvent is selected from the group consisting of a terpene, methyl soyate, ethyl lactate, methyl lactate, ethyl acetate, and any combinations thereof.

20. The composition of claim 12, wherein the unencapsulated peroxygen is present in an amount from about 0.01 to about 50 percent by weight, based on the total weight of the composition; and wherein the surfactant is present in an amount from about 0.01 to about 50 percent by weight, based on the total weight of the composition.
